(19) United States
(12) Patent Application Publication
(10) Pub. No.: US 2014/0249273 A1
(43) Pub. Date: Sep. 4, 2014

(54) SILANE END CAPPED SUBSTITUTED UREA RESINS AND COATINGS THEREOF

(71) Applicants: Arthur A. Webb, Bethesda, MD (US); Jozef Verborgt, Dunedin, FL (US)

(72) Inventors: Arthur A. Webb, Bethesda, MD (US); Jozef Verborgt, Dunedin, FL (US)

(73) Assignee: The Government of the United States of America, as represented by the Secretary of the Navy, Arlington, VA (US)

(21) Appl. No.: 14/190,446

(22) Filed: Feb. 26, 2014

Related U.S. Application Data
(60) Provisional application No. 61/772,132, filed on Mar. 4, 2013.

(51) Int. Cl. C09D 183/00

(52) U.S. Cl. CPC C09D 183/00
USPC 524/868; 556/421; 544/222; 524/858; 548/951; 556/417; 427/387

(57) ABSTRACT

The below compound, which may be made by reacting a 3-trialkoxysilylpropyl amine with an acrylic acid ester, a methacrylic acid ester, a diester of maleic acid, a diester of fumaric acid, or acrylonitrile to form a secondary amino propylalkoxysilane, and reacting the secondary amino propylalkoxysilane with an isocyanate. R¹ is an alkyl group, X is —CHR³—CHR⁴—CO—O—R² or —CH₂—CH₂—CN, R² is an organic group, R³ is —H or —CO—O—R², R⁴ is —H or —CH₃, but R⁴ is —H if R³ is —CO—O—R², R⁵ is an aliphatic group or a residue of hexamethylene diisocyanate cyclic trimer or hexamethylene diisocyanate cyclic dimer, and n is 2 or 3.

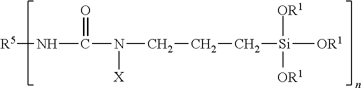

The below compound, which may be made by reacting a 3-trialkoxysilylpropyl amine with acrylonitrile. R¹ is an alkyl group.

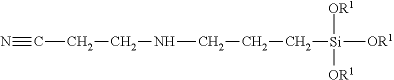

This application claims the benefit of U.S. Provisional Application No. 61/772,132, filed on Mar. 4, 2013. The provisional application is incorporated herein by reference.

### TECHNICAL FIELD

The present disclosure is generally related to one component cured coatings.

### DESCRIPTION OF RELATED ART

A large amount of solvent based silicone modified alkyds with a relatively high content of volatile solvents (VOCs) are presently used. All existing top coats show various amounts of VOCs depending on their chemistry and way of application. Even the use of VOC exempt solvents like OXSOL®, which is a fluorinated synthetic solvent, is not a good solution for the environment.

### BRIEF SUMMARY

Disclosed herein is a compound having the formula below. Each R¹ is an independently selected alkyl group. Each X is independently selected from —CHR³—CHR⁴—CO—O—R² and —CH₂—CH₂—CN. Each R² is an independently selected organic group. Each R³ is independently selected from —H and —CO—O—R². R⁴ is —H or —CH₃, with the proviso that R⁴ is —H if R³ is —CO—O—R². R⁵ is an aliphatic group or a residue of hexamethylene diisocyanate cyclic trimer or hexamethylene diisocyanate cyclic dimer. The value n is 2 or 3.

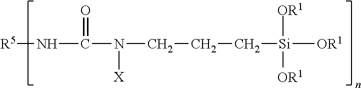

Also disclosed herein is a method comprising: reacting a 3-trialkoxysilylpropyl amine with an acrylic acid ester, a methacrylic acid ester, a diester of maleic acid, a diester of fumaric acid, or acrylonitrile to form a secondary amino propylalkoxysilane, and reacting the secondary amino propylalkoxysilane with an isocyanate to form the compound having the formula above.

Also disclosed herein is a compound having the formula below. Each R¹ is an independently selected alkyl group.

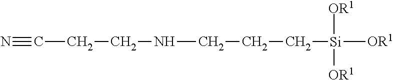

Also disclosed herein is a method comprising: reacting a 3-trialkoxysilylpropyl amine with acrylonitrile to form a secondary amino propylalkoxysilane having the formula above.

### DETAILED DESCRIPTION OF EXAMPLE EMBODIMENTS

In the following description, for purposes of explanation and not limitation, specific details are set forth in order to provide a thorough understanding of the present disclosure. However, it will be apparent to one skilled in the art that the present subject matter may be practiced in other embodiments that depart from these specific details. In other instances, detailed descriptions of well-known methods and devices are omitted so as to not obscure the present disclosure with unnecessary detail.

The present compositions allow for the formulation of odor free and solvent free one component moisture curing coatings that can easily be applied. The coatings can be brushed, rolled, or spray applied and cure into a hard, scratch resistant coating with an exceptional weatherability for a much extended service life. The coatings may strongly reduce the annual emission of VOCs and lower the cost of maintenance substantially. The coatings can also be formulated into self-extinguishing coatings for interiors of ships or can be formulated into CARC coatings with increased chemical resistance and cleanability.

Due to the intrinsic low viscosity of the resins the coatings can be formulated into aerosol coatings with substantially reduced amounts of solvents. The coatings may offer an interesting potential for use in commercial fleets as well as in the building and retail markets. Brush or roller applied coatings tend to have higher VOCs than coatings that are applied airless. The disclosed resins can provide VOC free application with airless spray equipment and 10% of less solvent for either brush or roller application.

Existing high quality urethanes, acrylates, and polysiloxanes are higher in VOC content. The weatherability of the disclosed resin is better than for urethanes and equals the weatherability of the best existing polysiloxanes. Note that all polysiloxanes do emit either methanol or ethanol during the curing stage.

The synthesis of the resins does not require any chemical reactors or capital investment and can be done in any existing paint factory. The two step reaction is done by mixing chemicals. The resin at the end of the two step process is entirely free of any active isocyanate and applicators or users will never be exposed to potentially harmful isocyanates.

Although there are secondary amino propyl alkoxy silanes commercially available, these tend to be expensive. The present compositions provide for a new abundant and more affordable source of secondary amino propyl silanes lowering the cost of the coating.

The first step of the reaction entails the production of a secondary amino propyl trialkoxy silane by way of a Michael addition reaction of an activated double bond to the primary amino group. The reagent can be either a diester of maleic acid or fumaric acid or an acrylic or methacrylic ester. Other reagents with activated double bond such as acrylonitrile can be used. Suitable reagents include, but are not limited to, diethyl maleate and butyl acrylate.

Both reagents are mixed neat under a blanket of inert and dry gas. A mild exotherm occurs after the addition which requires either mild cooling of the mixture or adding the mixture over an extended period of time. The bulk of the reaction is usually over in a few hours and the reaction product can then be stored in drums or tanks. The reaction is fully completed after some two to three days and is than ready to be used for the second step. Note that there is no need for purification of the reaction product.

The reactions of butyl acrylate with 3-trimethoxysilylpropyl amine and diethyl maleate with 3-triethoxysilylpropyl amine are shown below.

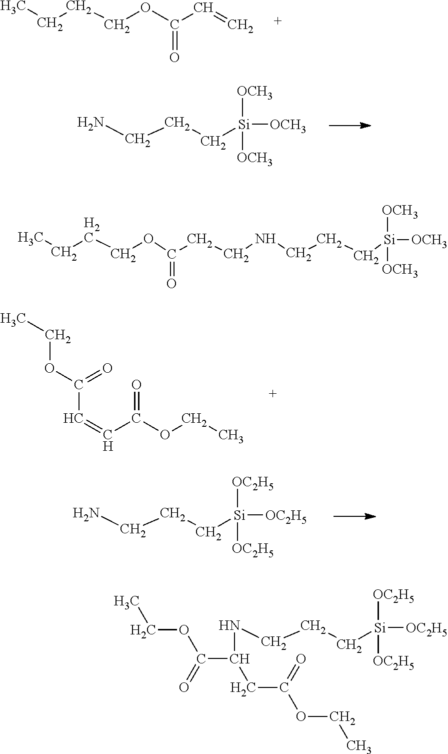

The second step is then carried out again preferably under a dry and inert blanket by adding stoichiometric amounts of an aliphatic isocyanate to the secondary amino propyl silane. This reaction can be done neat but can also be done in solution but preferably at very high concentrations. A mild exotherm does occur and it is advantageous to spread the addition of the isocyanate over a couple of hours or alternatively to apply some mild cooling. Note that the exotherm is limited and the reaction cannot get out of control thermally. The reaction is virtually complete after one hour at ambient temperature and the resin is ready to make paint or to be stored in tanks. Depending on the intended application it is possible to add solvents, plasticizers or reactive diluents before storing the resin in tanks.

The reactions of the above amines with bis(4-isocyanato-1,2,2,3,3,4,5,5,6,6-decamethylcyclohexyl)methane and hexamethylene diisocyanate cyclic trimer/dimer (DESMODUR® N3400) are shown below.

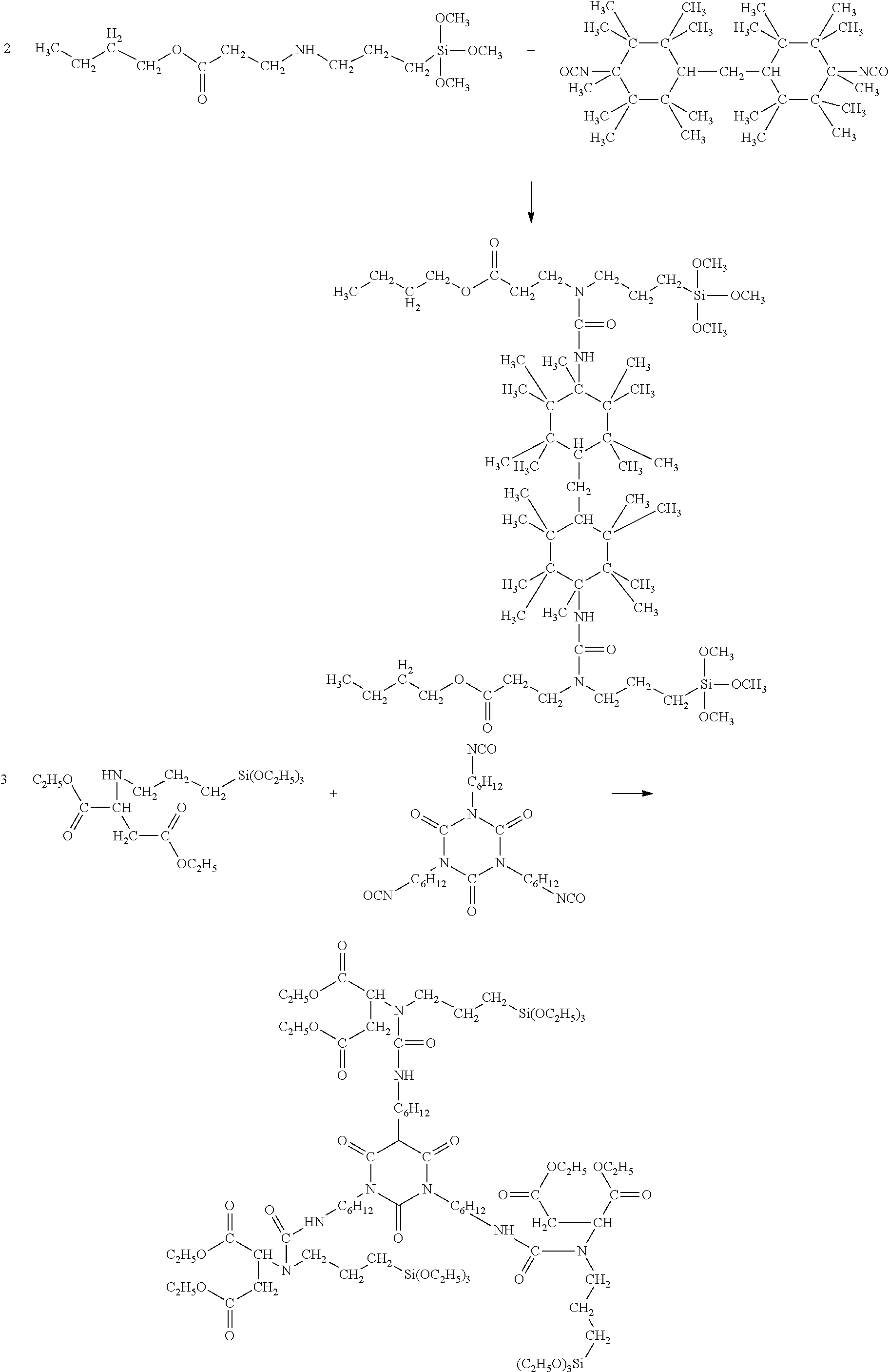

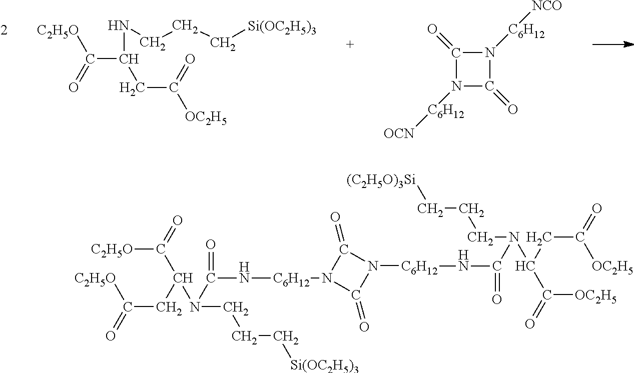

Coatings can then be produced by grinding the customary pigments, fillers, catalyst and additives. Grinding can be done by either cowless or sand mil or any other modern way of grinding paint.

The compositions may exhibit: 1) a new and abundant source of secondary amino propyl alkoxy silanes, 2) resins with a very low molecular weight and intrinsic low viscosity allowing for solvent free, odor free and relatively fast drying coatings, and 3) very good weathering equal to the best available siloxanes on the market.

The main problem of polysiloxanes is cost. By modifying the amino silane a good amount of cheap but performing “content” is added to the resin resulting in a commercially more attractive product opening up new markets. The new technology is very suitable for formulating self-extinguishing coatings, CARCs and other high performance camouflage coatings. The coatings are much more robust and scratch resistant than any other existing coating. The use of these coatings to protect aluminum is suitable and these coatings are prime candidates to replace existing high VOC coatings which are used today.

What is claimed is:

1. A compound having the formula: 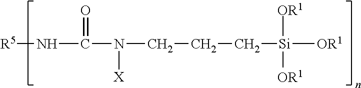
wherein each R¹ is an independently selected alkyl group;
wherein each X is independently selected from —CHR³—CHR⁴—CO—O—R² and —CH₂—CH₂—CN;
wherein each R² is an independently selected organic group;
wherein each R³ is independently selected from —H and —CO—O—R²;
wherein R⁴ is —H or —CH₃, with the proviso that R⁴ is —H if R³ is —CO—O—R²;
wherein R⁵ is an aliphatic group or a residue of hexamethylene diisocyanate cyclic trimer or hexamethylene diisocyanate cyclic dimer; and
wherein n is 2 or 3.

2. A coating made by a method comprising:
applying the compound of claim 1 to a surface.

3. A method comprising:
applying the compound of claim 1 to a surface.

4. The compound of claim 1, wherein each R¹ is methyl and each X is —CH₂—CH₂—CO—O—C₄H₉.

5. The compound of claim 4, wherein R⁵ is

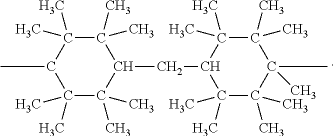

6. The compound of claim 1, wherein each R¹ is ethyl and each X is —CH(CO—O—C₂H₅)—CH₂—CO—O—C₂H₅.

7. The compound of claim 6, wherein R⁵ is

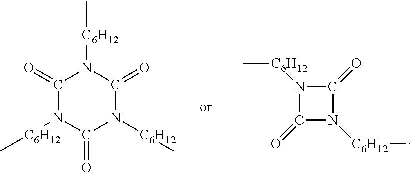

8. A coating made by a method comprising:
applying the compound of claim 7 to a surface; and
moisture curing the compound.

9. A method comprising:
applying the compound of claim 7 to a surface; and
moisture curing the compound.

10. A compound having the formula: 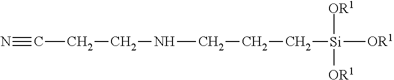
wherein each R¹ is an independently selected alkyl group.

11. A method comprising:
reacting a 3-trialkoxysilylpropyl amine with an acrylic acid ester, a methacrylic acid ester, a diester of maleic acid, a diester of fumaric acid, or acrylonitrile to form a secondary amino propylalkoxysilane; and
reacting the secondary amino propylalkoxysilane with an isocyanate to form the compound 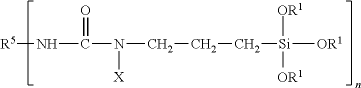
wherein each R¹ is an independently selected alkyl group;
wherein each X is independently selected from —CHR³—CHR⁴—CO—O—R² and —CH₂—CH₂—CN;
wherein each R² is an independently selected organic group;
wherein each R³ is independently selected from —H and —CO—O—R²;
wherein R⁴ is —H or —CH₃, with the proviso that R⁴ is —H if R³ is —CO—O—R²;
wherein R⁵ is an aliphatic group; and
wherein n is 2 or 3.

12. The method of claim 11, further comprising:
applying the compound to a surface.

13. The method of claim 11;
wherein the 3-trialkoxysilylpropyl amine is 3-trimethoxysilylpropyl amine; and
wherein the 3-trimethoxysilylpropyl amine is reacted with butyl acrylate.

14. The method of claim 13, wherein the isocyanate is bis(4-isocyanato-1,2,2,3,3,4,5,5,6,6-decamethylcyclohexyl)methane.

15. The method of claim 11;
wherein the 3-trialkoxysilylpropyl amine is 3-triethoxysilylpropyl amine; and
wherein the 3-triethoxysilylpropyl amine is reacted with diethyl maleate.

16. The method of claim 15, wherein the isocyanate is hexamethylene diisocyanate cyclic trimer or hexamethylene diisocyanate cyclic dimer.

17. The method of claim 15, further comprising:
applying the compound to a surface; and
moisture curing the compound.

18. A method comprising:
reacting a 3-trialkoxysilylpropyl amine with acrylonitrile to form a secondary amino propylalkoxysilane having the formula 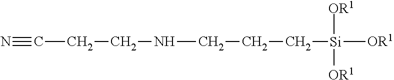
wherein each R¹ is an independently selected alkyl group.

19. The method of claim 18, further comprising:
reacting the secondary amino propylalkoxysilane with an isocyanate to form the compound 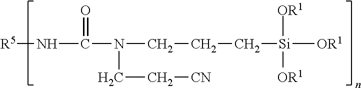
wherein R⁵ is an aliphatic group; and
wherein n is 2 or 3.
